(19) United States
(12) Patent Application Publication
(10) Pub. No.: US 2017/0361552 A1
(43) Pub. Date: Dec. 21, 2017

(54) TIRE MOLD AND VENT INSERT HAVING CORRESPONDING SURFACES

(71) Applicant: Bridgestone Americas Tire Operations, LLC, Nashville, TN (US)

(72) Inventor: Edward Steven SEROKA, Akron, OH (US)

(21) Appl. No.: 15/531,543

(22) PCT Filed: Dec. 21, 2015
(86) PCT No.: PCT/US2015/067038

§ 371 Date: May 30, 2017

Related U.S. Application Data
(60) Provisional application No. 62/095,450, filed on Dec. 22, 2014.

(51) Int. Cl. B29D 30/06

(52) U.S. Cl. CPC B29D 30/0606; B29D 2030/0617

(57) ABSTRACT

A system for venting a tire mold includes a tire mold having an interior region and an exterior region. The interior region is defined by a surface having a non-smooth portion that defines a pattern. The interior and exterior regions of the tire mold are in fluid connection with each other via at least one conduit extending from the exterior region to the non-smooth portion of the surface defining the interior region. The system further includes a vent insert at least partially disposed inside the at least one conduit. The vent insert has a non-smooth face that corresponds to the pattern defined by the non-smooth surface of the surface of the interior region.

### CROSS-REFERENCE TO RELATED APPLICATION

This application claims priority to U.S. Provisional Patent Application No. 62/095,450, filed on Dec. 22, 2014, the disclosure of which is incorporated by reference herein in its entirety.

### FIELD OF THE INVENTION

The present disclosure relates to venting structures for tire molds. More particularly, the present disclosure relates to a venting structure for a non-smooth portion of a sidewall-forming region of a tire mold.

### BACKGROUND

During the curing cycle of a tire manufacturing process, air may become trapped between a green tire and a mold cavity when a tire molding press is closed. This trapped air can cause “lightness” in the cured tire. One known method for evacuating this trapped air is through the use of vents. Vents are added in the mold and bead rings to bleed the air during the curing process. The vents may be directly drilled through the mold or bead rings, or a hole may be drilled through the mold or bead ring and a preformed insert is placed in the hole, thereby forming a vent.

During air evacuation, the elastomeric tire material may flow into the vents, creating projections on the surface of the tire known as sprues. Vent inserts may be employed to alter the air flow around the vents and prevent sprues from forming.

### SUMMARY

In one embodiment, a tire mold includes an interior surface having a non-smooth portion defined by at least one mold surface element selected from the group consisting of a raised surface and a recessed surface. The tire mold further includes a conduit extending from an opening in the non-smooth portion to an exterior of the tire mold. The tire mold also includes a vent insert located at least partially inside of the conduit. The vent insert has a face that is substantially flush with the tire mold interior surface. The face includes at least one face surface element selected from the group consisting of a raised surface and a recessed surface. The at least one face surface element corresponds to the at least one mold surface element.

In another embodiment, a system for venting a tire mold includes a tire mold having an interior region and an exterior region. The interior region is defined by a surface having a non-smooth portion that defines a pattern. The interior and exterior regions of the tire mold are in fluid connection with each other via at least one conduit extending from the exterior region to the non-smooth portion of the surface defining the interior region. The system further includes a vent insert at least partially disposed inside the at least one conduit. The vent insert has a non-smooth face that corresponds to the pattern defined by the non-smooth surface of the surface of the interior region.

In yet another embodiment, a tire mold includes an interior region and an exterior region. The interior and exterior regions of the tire mold are connected via at least one conduit extending from the exterior region to the interior region. The interior region is defined by an interior surface including a sidewall forming portion having multiple elevations. The at least one conduit has an opening in the sidewall forming portion of the interior surface. The tire mold further includes at least one vent insert having a face. At least a portion of the at least one vent insert is located inside the at least one conduit. The face has multiple elevations corresponding to the multiple elevations of the sidewall forming portion of the interior surface of the tire mold.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 is a side view of an exemplary tire;

FIG. 2 is a partial cross-section of a tire mold;

FIG. 3A is a front view of a portion of a tire mold and one embodiment of a vent insert;

FIG. 3B is a partial cross-section of the tire mold and vent insert of FIG. 3A;

FIG. 4A is a front view of a portion of a tire mold and an alternative embodiment of a vent insert;

FIG. 4B is a partial cross-section of the tire mold and vent insert of FIG. 4A;

FIG. 5A is a front view of a portion of a tire mold and another alternative embodiment of a vent insert;

FIG. 5B is a partial cross-section of the tire mold and vent insert of FIG. 5A;

FIG. 6A is a front view of a portion of a tire mold and yet another alternative embodiment of a vent insert;

FIG. 6B is a partial cross-section of the tire mold and vent insert of FIG. 6A;

FIG. 7A is a front view of a portion of a tire mold and still another alternative embodiment of a vent insert; and

FIG. 7B is a partial cross-section of the tire mold and vent insert of FIG. 7A.

### DETAILED DESCRIPTION

Directions are stated herein with reference to the tire mold. For example “interior,” “inside,” or “inner” refers to a direction or area towards the center cavity of a tire mold. The terms “exterior,” “outside,” or “outer” refer to a direction or area generally outside of the tire mold.

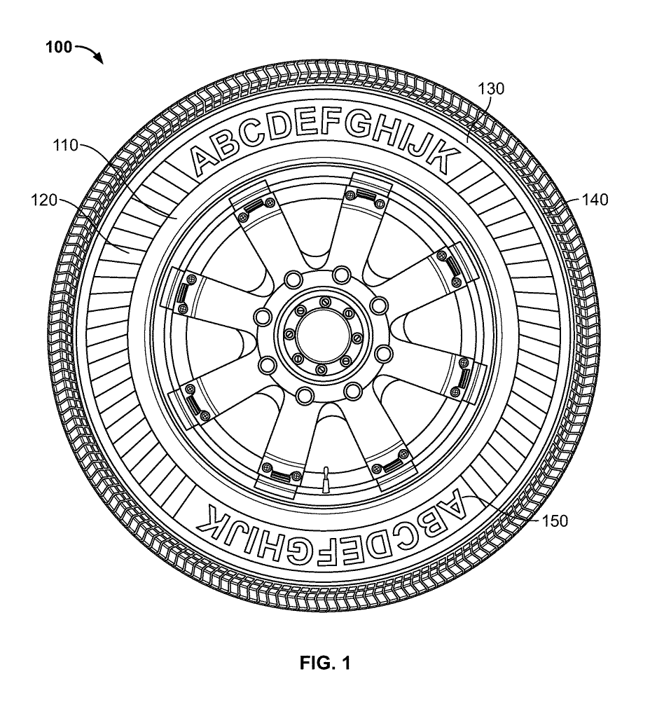

FIG. 1 illustrates a side view of an exemplary tire 100. The tire includes a sidewall 110 that includes both smooth portions and non-smooth portions. Non-smooth portions include serrations 120, which may also be referred to as notches, hatching, or cross-hatching. Serrations in a tire are defined by a series of projections, a series of recesses, or a series of alternating projections and recesses. Serrations may be defined by straight lines, curved lines, or a combination of straight and curved lines. The lines may cross each other or maintain separation.

Non-smooth portions also include grooves 130 or other recesses in the sidewall 110, as well as ribs 140 or other projections in the sidewall 110. Some non-smooth portions may form indicia, such as lettering 150. Other indicia include numbers and other symbols, such as logos. The indicia may be formed by recesses, projections, or a combination of recesses and projections. Alternatively, the indicia may be a smooth portion of a sidewall that is outlined by surrounding serrations.

Each of the above-described non-smooth portions forms a pattern. As used herein, “pattern” includes repeating series of elements, such as a repeating series of serrations, and also includes a single element. For example, a single, circumferential rib may be described as a pattern.

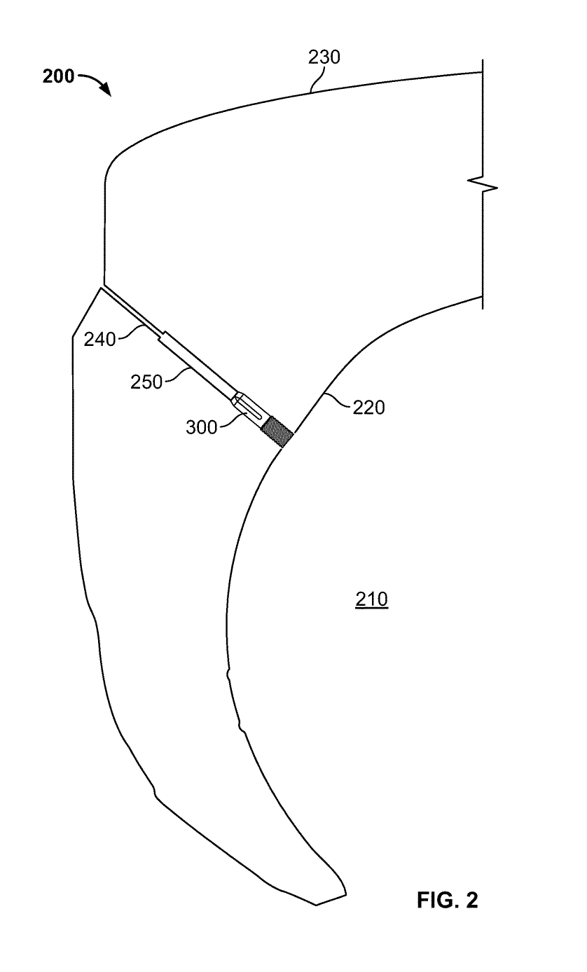

FIG. 2 illustrates a partial cross-section of an exemplary tire mold 200 that may be used to form the tire 100 of FIG. 1 or other tires. In the illustrated embodiment, the tire mold 200 includes an interior portion 210 defined by an interior surface 220, and an exterior surface 230. The interior surface 220 may take any shape suitable for forming tires. The tire mold 200 further includes a plurality of through holes (such as the illustrated through hole 240) extending from the interior surface 220 to the exterior surface 230. In one known embodiment, the through holes have a diameter of about 0.092 inches (0.23 centimeters). In other embodiments, the through holes may have diameters ranging from 0.050 inches (0.13 centimeters) to 0.25 inches (0.64 centimeters).

In the illustrated embodiment, each through hole 240 includes a counter-bore 250 extending outwardly from the interior surface 220. Together, the through hole 240 and the counter-bore 250 form a conduit for venting air from the interior 210 of the tire mold 200 to the exterior of the tire mold 200. The conduit may take any form, but here is depicted as cylindrical. An opening permits fluid communication between the interior 210 of the tire mold 200 and exterior. Other venting structures known in the art may be used without departing from the scope of the present disclosure.

The counter-bore 250 forms an opening in the interior surface 220 and receives a vent insert 300. The vent insert 300 may be employed to alter air flow around the openings of the conduit and prevent sprues from forming. Because the interior surface 220 includes curves and contours, each vent insert 300 may include a face that is similarly curved or contoured.

In one embodiment, the counter bore 250 and the vent insert 300 are substantially cylindrical. The vent insert 300 includes both a large diameter portion and a small diameter portion. In one embodiment, the large diameter is 0.125 inches (0.318 centimeters) and the small diameter is 0.062 inches (0.16 centimeters). In other embodiments, the large diameter ranges from 0.060 inches (0.15 centimeters) to 0.25 inches (0.64 centimeters) and the small diameter ranges from 0.030 inches (0.075 centimeters) to 0.125 inches (0.318 centimeters). In an alternative embodiment (not shown), the vent insert has a single diameter. In other alternative embodiments, the conduits and inserts have non-cylindrical shapes.

The diameter and length of the counter-bore 250 is dimensioned to accommodate the vent insert 300. In one embodiment, the diameter of the counter-bore 250 is 0.003 inches (0.008 centimeters) smaller than the largest diameter of the insert 300 to provide a light press fit of the insert 300. In alternative embodiments, the diameter of the counter-bore 250 is equal to or larger than the largest diameter of the insert 300. In such embodiments, the insert 300 can be held in place by one or more pins, adhesive, or other attachment means. In one known embodiment, each counter-bore 250 has a diameter of about 0.122 inches (0.310 centimeters). In other embodiments, the counter-bores may have diameters ranging from 0.060 inches (0.15 centimeters) to 0.25 inches (0.64 centimeters). In an alternative embodiment (not shown), the mold 200 does not include a counter-bore, and instead the entire through hole is sized to accommodate the vent insert.

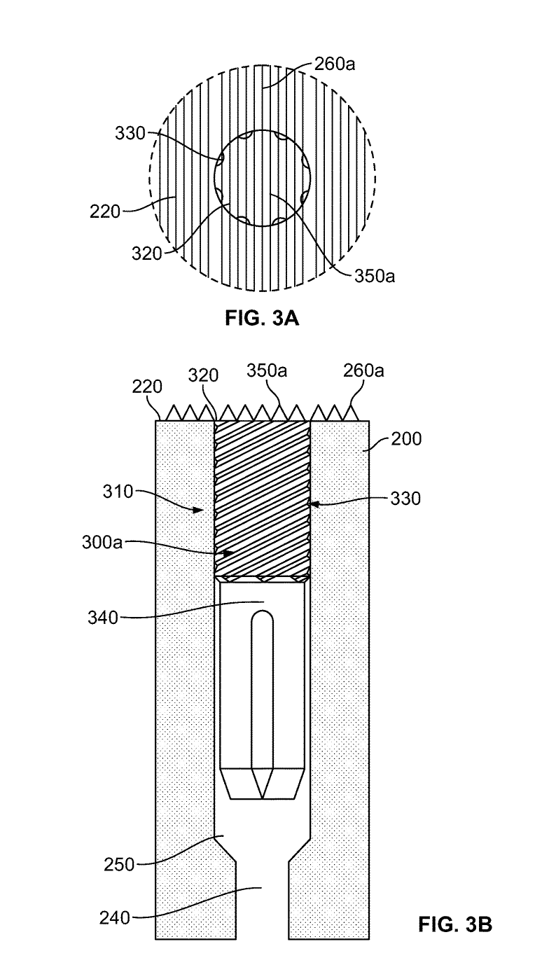

FIGS. 3A and 3B illustrate a partial front view and a partial cross-section, respectively, of a portion of the tire mold 200 and one embodiment of the vent insert 300a. The vent insert 300a includes a large diameter portion 310 with a face 320 that is substantially flush with the interior surface 220 of the tire mold 200. In an alternative embodiment (not shown), the face of the vent insert extends into the interior region of the tire mold. In another alternative embodiment (not shown), the vent insert is recessed such that the face of the vent insert is inside the conduit.

The vent insert 300a has a plurality of spiral channels 330 on the large diameter portion 310. Spiral channels 330 run continuously from the face 320 of the vent insert 300a along a portion of a length of the vent insert 300a. Each spiral channel 330 defines an intake opening along the face 320 of the vent insert 300a, as can be seen in FIG. 3A. In other embodiments, the spiral channels may be replaced with straight channels. Any number of channels may be employed. Additionally, other types of vent inserts may be used without departing from the scope of the present disclosure, including but not limited to spring vents, drill vents, micro vents, or sinter vents.

The vent insert 300a is a sprueless-type vent insert that allows gas from the interior 210 of the tire mold 200 to vent to an exterior of tire mold 200, reducing or preventing the formation of tire sprues. When tire material is injected into the tire mold 200, the air inside the tire mold 200 is displaced. The displaced air is forced into the intake openings through the channels 330 of the vent insert 300a in the counter bore 250. The air then travels along the large diameter portion 310 and the small diameter portion 340 of the vent insert 300a and out the through hole 240 until reaching the exterior of the tire mold 200. The shape and size of the intake openings, reducing or preventing the formation of tire sprues when tire material comes into contact with the interior surface 220 and the face 320.

In the illustrated embodiment, the vent insert 300a includes a plurality of raised surfaces, or projections 350a from the face 320 that extend into the interior 210 of the tire mold 200. The face 320 and the projections 350a form multiple elevations. The projections 350a extend from a peak, to a lower elevation. In the illustrated embodiment, the lower elevation is the same elevation as the face 320 of the vent insert 350a. In an alternative embodiment (not shown), the lower elevation is higher than the elevation of the face. In another alternative embodiment (not shown), the lower elevation is lower than the elevation of the face, such that the face has both projections and recesses.

The projections 350a correspond to projections 260a of the interior surface 220 in a non-smooth portion of a tread forming surface of a tire mold 200. Together, the projections 260a and 350a define serrations in a tire sidewall. The serrations may be part of any pattern in a sidewall, and may also form an outline of letters, numbers, symbols, or logos.

The projections 350a of the vent insert 300a and the projections 260a of the tire mold 200 have triangular cross sections. In alternative embodiments (not shown), the projections are rectangular, trapezoidal, round, or have any geometric cross-section.

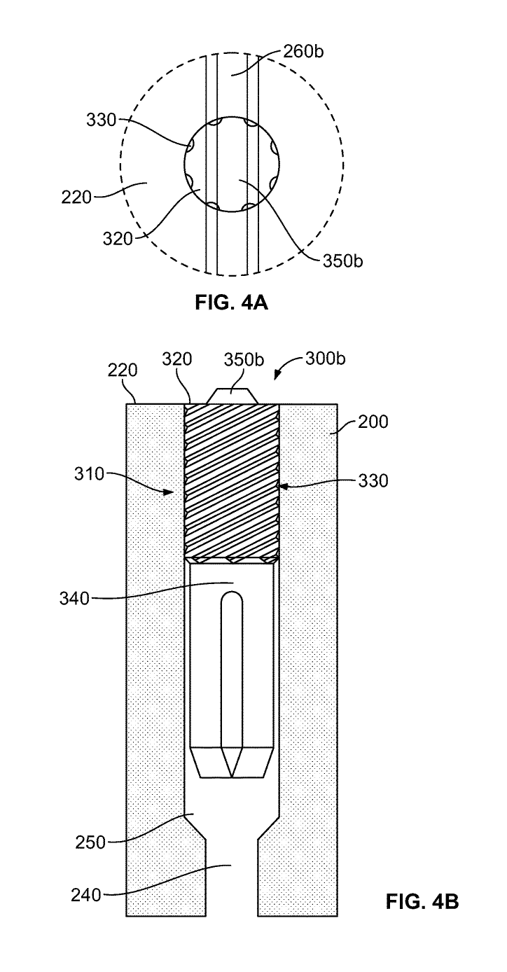

FIGS. 4A and 4B illustrate a partial front view and a partial cross-section, respectively, of a portion of the tire mold 200 and an alternative embodiment of the vent insert 300b. The vent insert 300b is substantially the same as the vent insert 300a described above with respect to FIGS. 3A and 3B (including the alternative embodiments discussed therein) except for the differences described below. Like reference numerals are used for like elements.

In the illustrated embodiment, the vent insert 300b includes a raised surface, or projection 350b from the face 320 that extends into the interior 210 of the tire mold 200. The face 320 and the projection 350b form multiple elevations. The projection 350b corresponds to a projection 260b of the interior surface 220 in a non-smooth portion of a tread forming surface of a tire mold 200. Together, the projections 260b and 350b define a recess in a tire sidewall. The recess that is formed may be part of any pattern in a sidewall, and may form a groove, letters, numbers, symbols, or logos.

The projection 350b of the vent insert 300b and the projection 260b of the tire mold 200 both have trapezoidal cross sections. In alternative embodiments (not shown), the projections are rectangular, triangular, or have any geometric cross-section.

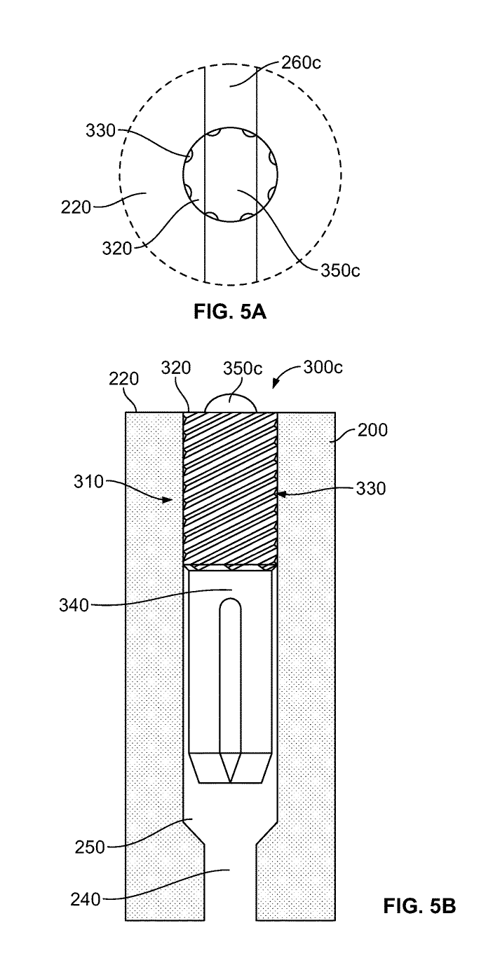

FIGS. 5A and 5B illustrate a partial front view and a partial cross-section, respectively, of a portion of the tire mold 200 and another alternative embodiment of the vent insert 300c. The vent insert 300c is substantially the same as the vent inserts 300a and 300b described above with respect to FIGS. 3A-4B (including the alternative embodiments discussed therein) except for the differences described below. Like reference numerals are used for like elements.

In the illustrated embodiment, the vent insert 300c includes a raised surface, or projection 350c from the face 320 that extends into the interior 210 of the tire mold 200. The face 320 and the projection 350c form multiple elevations. The projection 350c corresponds to a projection 260c of the interior surface 220 in a non-smooth portion of a tread forming surface of a tire mold 200. Together, the projection 260c and 350c define a recess in a tire sidewall. The recess that is formed may be part of any pattern in a sidewall, and may form a groove, letters, numbers, symbols, or logos.

The projection 350c of the vent insert 300c and the projection 260c of the tire mold 200 each have a round cross section, defined by a single radius. In an alternative embodiment (not shown), the projections are curved but are defined by multiple radii. In another alternative embodiment (not shown), the projections are defined by a geometric curve, such as a parabola, an ellipse, or a hyperbola.

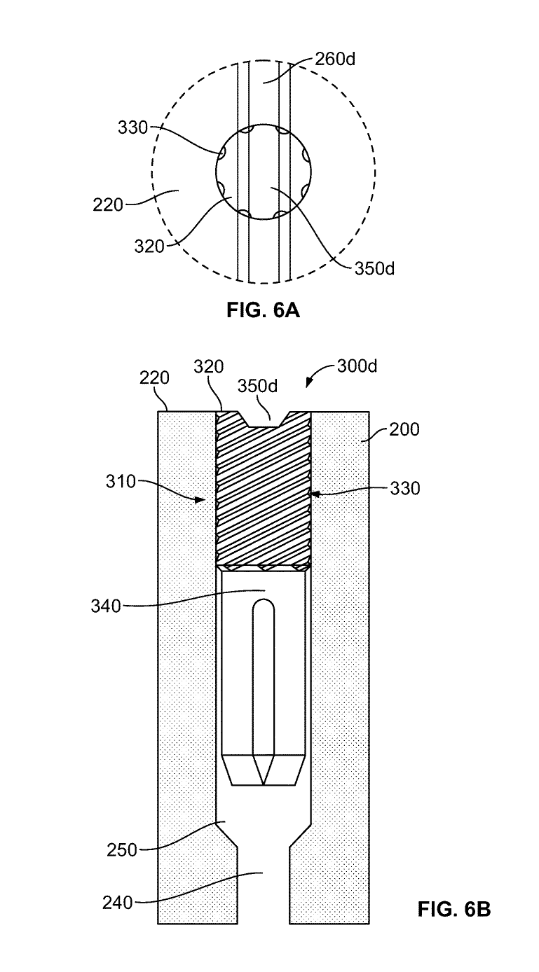

FIGS. 6A and 6B illustrate a partial front view and a partial cross-section, respectively, of a portion of the tire mold 200 and yet another alternative embodiment of the vent insert 300d. The vent insert 300d is substantially the same as the vent inserts 300a, 300b, and 300c described above with respect to FIGS. 3A-5B (including the alternative embodiments discussed therein) except for the differences described below. Like reference numerals are used for like elements.

In the illustrated embodiment, the vent insert 300d includes a recessed surface 350d in the face 320. The face 320 and the recess 350d form multiple elevations. The recess 350b corresponds to a recess 260d of the interior surface 220 in a non-smooth portion of a tread forming surface of a tire mold 200. Together, the recesses 260d and 350d define a projection in a tire sidewall. The projection that is formed may be part of any pattern in a sidewall, and may form a rib, letters, numbers, symbols, or logos.

The recess 350d of the vent insert 300d and the recess 260d of the tire mold 200 have trapezoidal cross sections. In alternative embodiments, the recesses are rectangular, triangular, or have any geometric cross-section.

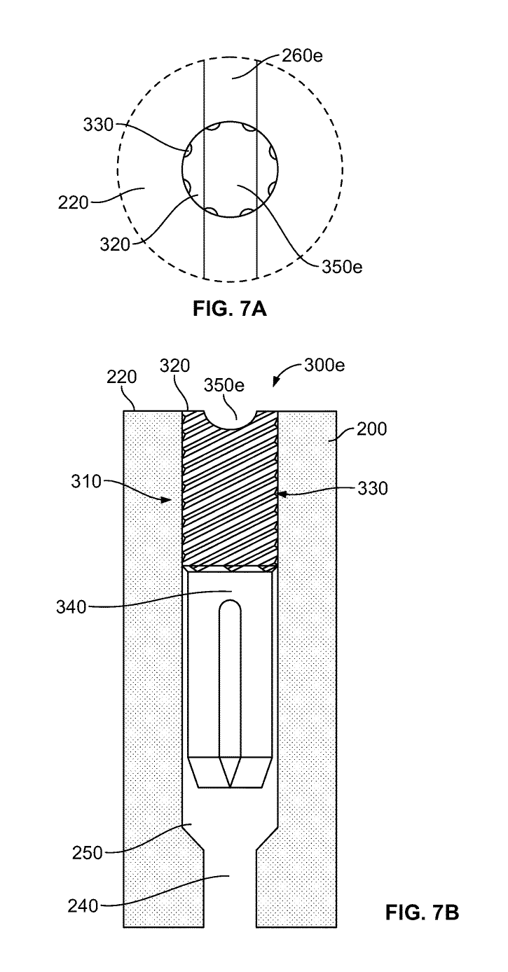

FIGS. 7A and 7B illustrate a partial front view and a partial cross-section, respectively, of a portion of the tire mold 200 and still another alternative embodiment of the vent insert 300e. The vent insert 300e is substantially the same as the vent inserts 300a, 300b, 300c, and 300d described above with respect to FIGS. 3A-6B (including the alternative embodiments discussed therein) except for the differences described below. Like reference numerals are used for like elements.

In the illustrated embodiment, the vent insert 300e includes a recess 350e in the face 320. The face 320 and the recess 350e form multiple elevations. The recess 350e corresponds to a recess 260e of the interior surface 220 in a non-smooth portion of a tread forming surface of a tire mold 200. Together, the recess 260e of the interior surface 220 of the tire mold and the recess 350e of the face 320 of the vent insert 300e define a projection in a tire sidewall. The formed projection may be part of any pattern in a sidewall, and may form a rib, letters, numbers, symbols, or logos.

The recess 350e of the vent insert 300e and the recess 260e of the tire mold 200 each have a round cross section, defined by a single radius. In an alternative embodiment (not shown), the recesses are curved but are defined by multiple radii. In another alternative embodiment (not shown), each recess is defined by a geometric curve, such as a parabola, an ellipse, or a hyperbola.

It should be understood that the embodiments illustrated in FIGS. 3A-7B are merely exemplary, and that other projections and recesses may be employed. For example, a vent insert may include a combination of both recesses and projections.

While only vent inserts for non-smooth portions of a sidewall forming surface are shown, it should be understood that additional conduits and vent inserts may be employed in smooth portions of a sidewall forming surface. Such a vent insert would not include projections or recesses.

Additionally, while the vent inserts are generally described as being used in a sidewall-forming portion of a tire mold, they may also be employed in a bead-forming portion or a shoulder forming portion of a tire mold. They may also be employed in the tread portion of a tire mold.

In one embodiment, the tire mold 200 and vent inserts 300 are formed of the same material. Exemplary material includes steel, aluminum, and other metal. In an alternative embodiment, the tire mold is made of metal and the vent inserts 300 are made of thermoplastic. Thermoplastic may be easier to cut, mold, or otherwise shape to include the desired projections and recesses. In another alternative embodiment, vent inserts that are used in smooth portions of a sidewall-forming surface are constructed of metal, while vent inserts that are used in non-smooth portions of a sidewall forming surface are constructed of thermoplastic.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A tire mold comprising:
a tire mold interior surface having a non-smooth portion defined by at least one mold surface element selected from the group consisting of a raised surface and a recessed surface;
a conduit extending from an opening in the non-smooth portion of the tire mold interior surface to an exterior of the tire mold; and
a vent insert located at least partially inside of the conduit, the vent insert having a face that is substantially flush with the tire mold interior surface,
wherein the face includes at least one face surface element selected from the group consisting of a raised surface and a recessed surface, and
wherein the at least one face surface element corresponds to the at least one mold surface element.

2. The tire mold of claim 1, wherein the tire mold interior surface further includes a smooth portion.

3. The tire mold of claim 2, further comprising:
a second conduit extending from a second opening in the smooth portion of the tire mold interior surface to an exterior of the tire mold; and
a second vent insert located at least partially inside of the second conduit, wherein the second vent insert has a face that is substantially flush with the tire mold interior surface.

4. The tire mold of claim 1, wherein the vent insert has a plurality of vent insert channels extending along a vent insert side surface, and wherein each vent insert channel has an intake opening at the face.

5. The tire mold of claim 1, wherein the at least one mold surface element and the at least one face surface element together define a serrated surface.

6. The tire mold of claim 1, wherein the at least one mold surface element and the at least one face surface element together define an indicium.

7. The tire mold of claim 1, wherein the at least one mold surface element and the at least one face surface element together define one of a groove and a rib.

8. The tire mold of claim 1, wherein the non-smooth portion of the tire mold interior surface includes a recess, and wherein the at least one face surface element is a corresponding recess.

9. A method of venting a tire mold, the method comprising:
providing a tire mold having an interior region and an exterior region,
wherein the interior region is defined by a surface having a non-smooth portion,
wherein the non-smooth surface defines a pattern,
wherein the interior and exterior regions of the tire mold are in fluid connection with each other via at least one conduit extending from the exterior region to the non-smooth portion of the surface defining the interior region; and
inserting a vent insert at least partially inside the at least one conduit, the vent insert having a non-smooth face that corresponds to the pattern defined by the non-smooth surface of the surface of the interior region.

10. The method of claim 9, wherein the inserting the vent insert includes inserting the vent insert such that the non-smooth face of the vent insert is flush with the non-smooth portion of the surface of the interior region.

11. The method of claim 9, wherein the vent insert has a plurality of channels extending along a vent insert side surface, wherein each channel has an intake opening at the non-smooth face.

12. The method of claim 9, wherein the pattern is selected from the group consisting of: at least one serration, at least one rib, at least one groove, at least one letter, at least one number, at least one symbol, and at least one logo.

13. The method of claim 9, wherein the surface of the interior region is contoured, and the non-smooth face of the vent insert has a corresponding contour.

14. The method of claim 9, wherein the non-smooth portion of the surface of the interior region corresponds to a bead portion of a tire.

15. The method of claim 9, wherein the vent insert is constructed of thermoplastic.
